(19) United States
(12) Patent Application Publication
(10) Pub. No.: US 2024/0268375 A1
(43) Pub. Date: Aug. 15, 2024

(54) CRYOGENIC CASSETTES AND ASSOCIATED SYSTEMS, DEVICES, AND METHODS

(71) Applicant: Sana Biotechnology, Inc., Seattle, WA (US)

(72) Inventor: Lindong Weng, Seattle, WA (US)

(21) Appl. No.: 18/570,366

(22) PCT Filed: Jun. 22, 2022
(86) PCT No.: PCT/US22/34535

§ 371 Date: Dec. 14, 2023

Related U.S. Application Data
(60) Provisional application No. 63/215,013, filed on Jun. 25, 2021.

(51) Int. Cl. A01N 1/02

(52) U.S. Cl. CPC A01N 1/0263

(57) ABSTRACT

Cryogenic cassettes (“cryocassettes”) and associated systems, devices, and methods are described herein. In one embodiment, a cryocassette includes a cover and a body portion configured to slidably receive the cover. The body portion can include a backwall and a plurality of sidewalls that form a tray structure for carrying a cryobag. The body portion can slidably receive the cover in a notch formed in one or more sidewalls of the plurality of sidewalls to, for example, retain the cryobag between the backwall of the body portion and the cover. The backwall and/or the plurality of sidewalls can include one or more openings for air or another medium to flow through the backwall and/or the plurality of sidewalls. The cover and/or the body portion can be transparent. In these and other embodiments, the cryocassette can include a product label corresponding to a product contained within the cryobag.

### CROSS-REFERENCE TO RELATED APPLICATIONS

This application claims the benefit of U.S. Provisional Patent Application No. 63/215,013, filed Jun. 25, 2021, which is incorporated by reference herein in its entirety.

### TECHNICAL FIELD

The present disclosure relates generally to cryogenic cassettes and associated systems, devices, and methods. For example, embodiments of the present technology relate to cryogenic cassettes for cryopreservation of biological material.

### BACKGROUND

Cryopreservation is a process by which biological material (e.g., tissue, cells, etc.) is preserved by cooling the biological material to low temperatures (e.g., to approximately −130° Celsius or less). At these low temperatures, enzymatic or chemical activity that might otherwise damage the biological material is slowed or effectively stopped. When cryopreservation procedures are optimized, detrimental events (e.g., osmotic shock, intracellular ice formation, ice recrystallization, etc.) can be avoided to ensure viability and functionality of post-thaw biological material. Thus, cryopreservation can successfully preserve biological material for use at a later time, at which point the biological material can be thawed.

A common method of cooling biological material to the low temperatures required for cryopreservation is controlled-rate and slow freezing (also known as slow programmable freezing). During controlled-rate and slow freezing, the biological material is cooled in accordance with programmable sequences. For example, a controlled-rate freezer or other instrument can be used to cool biological material at a specified rate (e.g., 1° Celsius per minute) until the biological material reaches a desired temperature. In some instances, the biological material can then be transferred to a storage container where the biological material can be cryopreserved in liquid nitrogen (LN₂).

Biological material destined for cryopreservation is often stored in cryopreservation bags (also known as cryogenic freezing bags, or cryobags) before the biological material is frozen. The cryopreservation bags can then be placed in cryogenic cassettes or cannisters (also known as cryopreservation cassettes, or cryocassettes) that can be installed in racks positioned within a controlled-rate freezer, a LN₂ storage container, or another cooling instrument. The cryogenic cassettes and storage racks facilitate a more uniform freezing of the biological material stored within the cryobags by storing the cryobags in a flat orientation and spacing the cryobags apart from one another within the controlled-rate freezer, the LN₂ storage container, or the other cooling instrument.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure. The drawings should not be taken to limit the disclosure to the specific embodiments depicted, but are for explanation and understanding only.

FIG. 1 is a partially schematic, perspective view of a cryogenic cassette configured in accordance with various embodiments of the present technology.

FIG. 2 is a partially schematic, perspective view of another cryogenic cassette configured in accordance with various embodiments of the present technology.

FIG. 3 is a front view of a cryopreservation bag configured in accordance with various embodiments of the present technology.

FIG. 4A is a partially schematic, perspective view of a cryogenic cassette installed in a storage rack configured in accordance with various embodiments of the present technology.

FIG. 4B is a partially schematic, perspective view of a cryogenic cassette installed in another storage rack configured in accordance with various embodiments of the present technology.

FIG. 4C is a front view of a controlled-rate freezer configured in accordance with various embodiments of the present technology.

FIG. 4D is a front view of a liquid nitrogen storage container configured in accordance with various embodiments of the present technology.

FIG. 5 is a flow diagram illustrating a method of cryopreserving biological material in accordance with various embodiments of the present technology.

### DETAILED DESCRIPTION

### A. Overview

The following disclosure describes cryogenic cassettes (“cryocassettes”), and associated devices, systems, and methods. In one embodiment, a cryocassette of the present technology includes a body portion and a cover. The body portion can include a backwall and a plurality of sidewalls. The backwall and/or the plurality of sidewalls can include holes or cutouts to facilitate air flow through the cryocassette. The sidewalls can further include one or more notches configured to slidably receive and retain the cover. A cryopreservation bag (a “cryobag”) can be positioned between the backwall of the body portion and the cover when the cover is slidably installed in a notch of the body portion. The cryocassette can be installed into a storage rack, such as a rack configured for installation into a controlled-rate freezer or a liquid nitrogen storage container for cryopreserving biological material.

As discussed above, it is often desirable to store biological material (e.g., tissue, cells, etc.) at low temperatures, such as within a controlled-rate freezer or a liquid nitrogen storage container (e.g., for cryopreservation). To facilitate controlled and uniform freezing of the biological material, cryobags storing biological material can be inserted into cryocassettes, and the cryocassettes can be placed within the controlled-rate freezer and/or the liquid nitrogen storage container. In particular, the cryocassettes can be installed into storage racks that can be positioned within the controlled-rate freezer and/or the liquid nitrogen storage container. The storage racks facilitate multi-dimensional stacking of the cryocassettes while maintaining a spacing between individual cryocassettes to facilitate controlled and/or uniform freezing of the biological material.

Many cryocassettes include a folder or clam-shell architecture having a front flap and a back flap. The front and back flaps are often held together via one or more hinges located at rear edges of the flaps. When the front and back flaps are in an open position, a cryobag can be positioned on an inner surface of the back flap. The front flap can then be swung forward to place the cryocassette into a closed position and thereby retain the cryobag between the front and back flaps. Some of these cryocassettes further include a swivel lock positioned at a front edge of the back flap that is configured to retain the flaps in the closed position. In particular, an arm of the swivel lock can be anchored to a front edge portion of the back flap via a hinge. When the front and back flaps are in the closed position, the arm of the swivel lock can be swung to a closed position such that a lip of the arm is positioned over a front edge portion of the front flap to lock the front and back flaps together in the closed positioned. These and other cryocassettes can include a small cutout in the front flap that serves as a thumb hole through which a user can reposition a cryobag stored within a cryocassette (e.g., to read a portion of a label affixed to the cryobag) while the cryocassette is in the closed portion.

The inventor of the present technology has realized several problems and disadvantages with the cryocassettes described above. For example, the inventor has recognized that the above cryocassettes are often manufactured with sharp edges and/or corners, such as about a perimeter of the front flap, the back flap, the cutout, and/or the arm of the swivel lock. These sharp edges and/or corners pose a risk of cutting, puncturing, or otherwise damaging a cryobag, especially as the front and back covers are swung into the closed position or as a user attempts to reposition the cryobag via the small cutout. In addition, the sharp edges and/or corners pose a risk of injuring an operator. As another example, the inventor has realized that the above cryocassettes are often difficult to open, especially when the cryocassette is frozen. In particular, the swivel lock and/or the flaps often become frozen into the locked and/or closed positions, and the above cryocassettes do not provide a gripping means to open the cassette without use of excessive force or waiting for the cryocassette to thaw.

In addition, the flaps of some of the cryocassettes described above have a limited range of motion. For example, the front flaps on many of the above cryocassettes do not swing into a fully open position (e.g., 180° or more with respect to the back flaps), which limits access to the inner surfaces of the back flaps for positioning cryobags within or retrieving cryobags from the cryocassettes. Furthermore, aside from the small cutouts in the front flaps, the front and back flaps of many of the above cryocassettes are solid, opaque sheets of material that lack holes or openings. The inventor has noticed that the lack of cutouts in the above cryocassettes stifles air flow through a controlled-rate freezer or a liquid nitrogen storage container and complicates controlled and/or uniform freezing of biological material stored within the cryocassettes. Moreover, the small size of the cutouts in the front flaps of the above cryocassettes often limit the amount of information users can view through these cutouts on labels affixed to cryobags stored within the cryocassettes. Thus, users often must open the cryocassettes to view larger amounts of information printed on labels affixed to cryobags, especially when the labels are much larger than the cutouts in the front flaps of the cryocassettes. This additional handling of the cryocassettes and/or the cryobags can pose a further risk of cutting, puncturing, or otherwise damaging the cryobags and/or the biological material stored therein. In addition, the quality (e.g., viability, functionality, etc.) of the frozen biological material can be compromised due to temperature changes that can occur when the users open the cryocassettes to view information printed on labels affixed to the cryobags.

To address these concerns, the inventor has developed cryocassettes that each have a body portion and a cover that slidably interfaces with the body portion to retain a cryobag between the cover and a backwall of the body portion. The body portion and/or the cover can be manufactured such that it includes rounded corners and lacks other sharp edges that could potentially cut, puncture, or otherwise damage a cryobag. In addition, sliding the cover into the body portion to retain the cryobag within the cryocassette is expected to reduce the possibility of damaging the cryobag in comparison to swinging flaps closed about a cryobag (as discussed above). In some embodiments, the cover can include a gripping ridge or lip that can be used to slide the cover into or out of the body portion, thereby facilitating easier installation or removal of the cover even when the cryocassette is frozen. In these and other embodiments, the cover can be removed from the body portion to expose all or a significant majority of the inner surface of the backwall of the body portion. Thus, cryocassettes of the present technology offer a greater amount of access to the interior of the body portion than many of the cryocassettes described above.

Additionally, or alternatively, the body portion and/or the cover can include one or more openings (e.g., holes, cutouts, etc.) to expose at least a portion of a cryobag stored within the cryocassette and/or to facilitate air flow through the cryocassette. The openings are expected to (a) improve air flow through a controlled-rate freezer and/or a liquid nitrogen storage container and/or (b) improve control over and/or uniformity of the freezing process of biological material stored within a cryocassette (e.g., regardless of the position of the cryocassette within the controlled-rate freezer and/or the liquid nitrogen storage container). In these and other embodiments, the cover can be transparent to facilitate viewing all or a significant majority of a label affixed to a cryobag stored within the cryocassette. Additionally, or alternatively, a label can be affixed to or printed on the cover such that the cover can include patient or other information related to biological material stored within a cryobag positioned within the cryocassette.

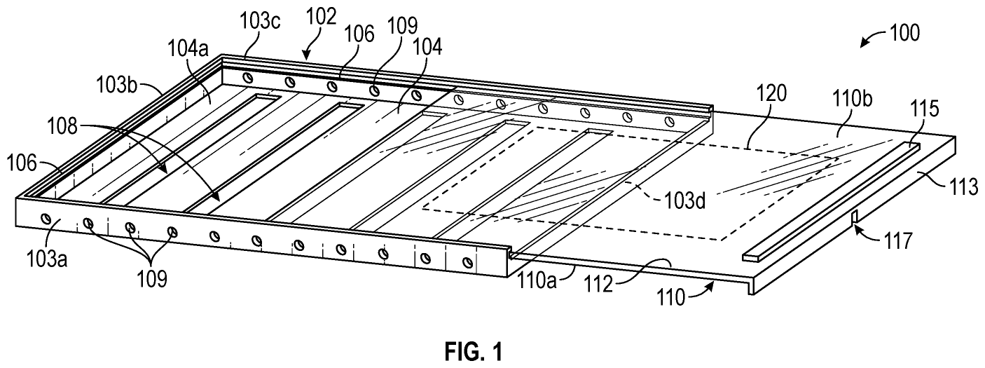

Certain details are set forth in the following description and in FIGS. 1-5 to provide a thorough understanding of various embodiments of the present technology. Other details describing well-known structures, systems, and methods often associated with cryocassettes and/or cryopreservation procedures, however, are not set forth below to avoid unnecessarily obscuring the description of various embodiments of the technology.

Many of the details, dimensions, angles, and other features shown in FIGS. 1-5 are merely illustrative of particular embodiments of the technology. Accordingly, other embodiments can have other details, dimensions, angles, and features without departing from the spirit or scope of the present technology. In addition, those of ordinary skill in the art will appreciate that further embodiments of the technology can be practiced without several of the details described below.

### B. Selected Embodiments of Cryogenic Cassettes, and Associated Systems, Devices, and Methods

### 1. Cryogenic Cassettes Associated Systems and Devices

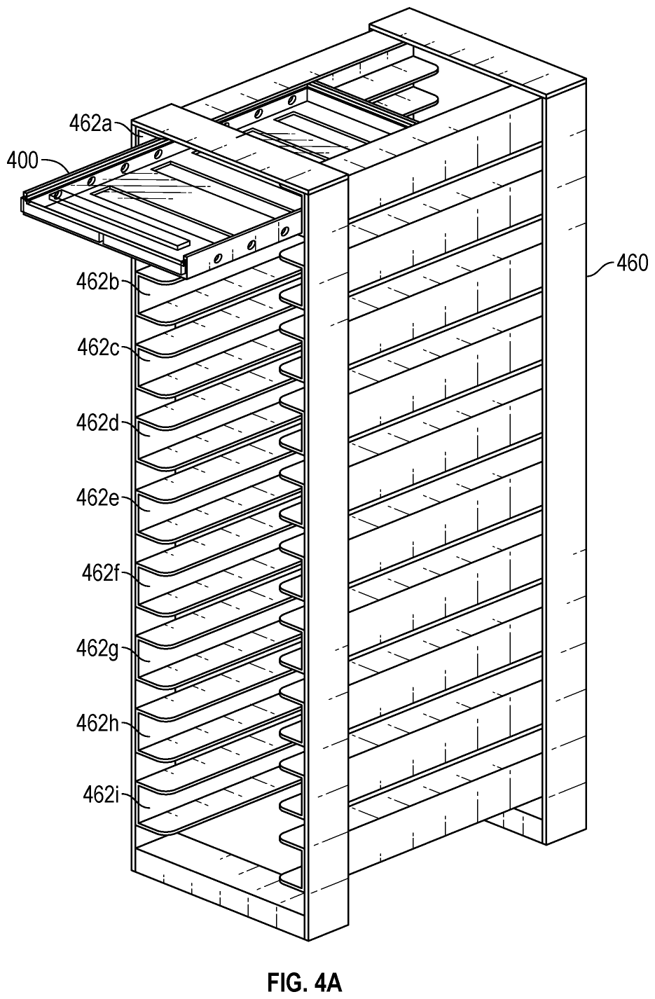

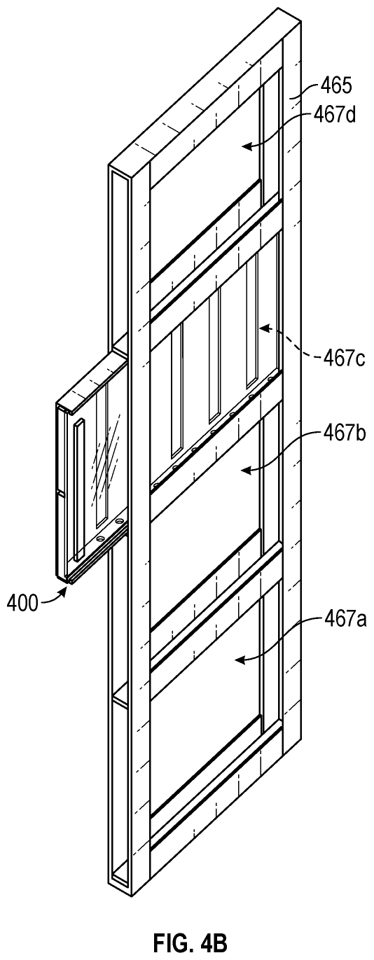

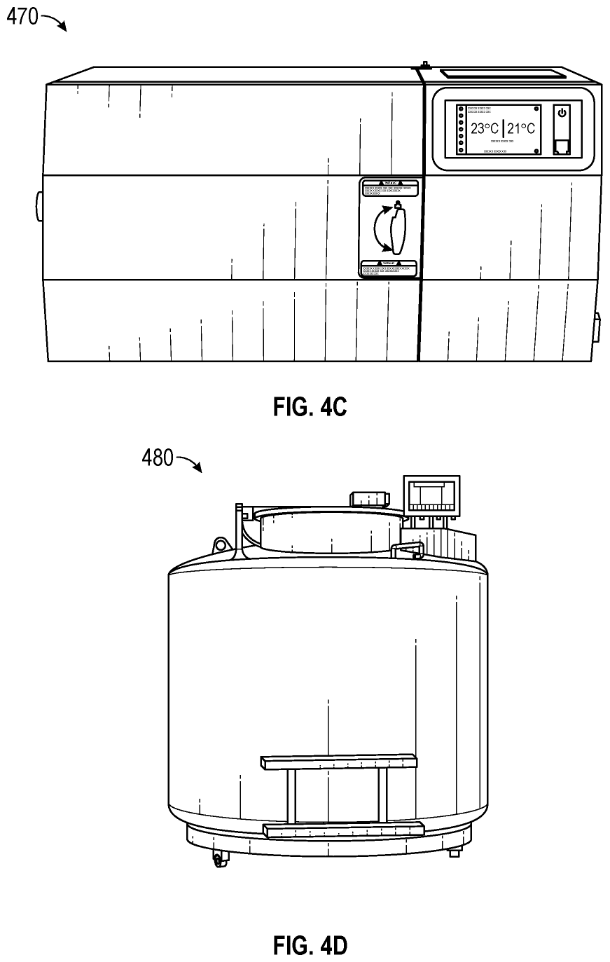

FIG. 1 is a partially schematic, perspective view of a cryogenic cassette 100 (“cryocassette 100”) configured in accordance with various embodiments of the present technology. As shown, the cryocassette 100 includes a body portion 102 and a cover 110. The cryocassette 100 of FIG. 1 has a generally rectangular shape. In other embodiments, the cryocassette 100 can include another general shape. For example, the cryocassette 100 can have a generally circular shape. In these and other embodiments, the cryocassette 100 can have a general shape corresponding to a general shape of a cryobag (not shown) that the cryocassette 100 is configured to carry. As described in greater detail below with respect to FIGS. 4A-4D, the cryocassette 100 can additionally or alternatively be dimensioned and shaped such that the cryocassette 100 fits within and/or can be carried by a storage rack of a controlled-rate freezer, a liquid nitrogen storage container, and/or another instrument.

The body portion 102 and the cover 110 of the cryocassette 100 can be formed of one or more suitable materials that maintain integrity at cryogenic temperatures. For example, the body portion 102 and/or the cover 110 can be formed of one or more metals, glasses, and/or thermoplastics (e.g., polypropylene, polycarbonate, etc.). In the illustrated embodiment, the body portion 102 is formed of a metallic material, and the cover 110 is formed of a thermoplastic material. In some embodiments, all or a portion of the body portion 102 and/or all or a portion of the cover 110 can be formed via injection molding, three-dimensional (3D) printing, and/or another suitable manufacturing technique.

The body portion 102 includes a backwall 104 and a plurality of sidewalls 103 (identified individually as sidewalls 103a-103d in FIG. 1). The backwall 104 includes an inner surface 104a, and the sidewalls 103 include inner sides generally facing the inner surface 104a of the backwall 104. The backwall 104 and/or one or more of the sidewalls 103a-103d can be manufactured such that they lack (a) rough or sharp edges and/or (b) rough or sharp corners. For example, the backwall 104 and/or one or more of the sidewalls 103a-103d can be formed with rounded or blunted edges and/or corners.

The backwall 104 and the sidewalls 103 are arranged to form a tray-like structure for carrying a cryobag. In other words, the backwall 104 and the sidewalls 103 of the body portion 102 can be sized and/or shaped for one or more sizes and/or shapes of cryobags such that, when a corresponding cryobag is positioned on the inner surface 104a of the backwall 104, (i) the backwall 104 supports the cryobag and (ii) the sidewalls 103 generally surround a perimeter of the cryobag.

In the illustrated embodiment, the sidewalls 103a-103c have a first height, and the sidewall 103d has a second height smaller than the first height. The sidewall sidewalls 103a-103c further include a notch 106 (e.g., a groove, a recess, etc.) at a height along the inner sides of the sidewalls 103a-103c that is above the second height of the sidewall 103d. As discussed in greater detail below, the sidewalls 103a-103c are configured to (a) slidably receive the cover 110 within the notch 106 and (b) limit vertical movement of the cover 110 (with respect to the inner surface 104a of the backwall 104 of the body portion 102) while the cover 110 is inserted within the notch 106.

Although illustrated with a sidewall 103d in FIG. 1, the sidewall 103d can be omitted in other embodiments. For example, the body portion 102 can include only the sidewalls 103a, 103b, and/or 103c in some embodiments. Additionally, or alternatively, the sidewall 103b can lack a notch 106 in some embodiments. Omitting the sidewall 103d can facilitate positioning the notch 106 at lower heights along the inner sides of the sidewalls 103a-103c than shown in FIG. 1, which can reduce a distance between the inner surface 104a of the backwall 104 and an inner surface 110a of the cover 110 when the cover 110 is installed within the notch 106. The reduced distance can facilitate securing cryobags having smaller thicknesses within the cryocassette 100.

Referring again to FIG. 1, the backwall 104 of the body portion 102 includes one or more openings 108 (e.g., holes, cutouts, slots, etc.) extending through the backwall 104. In particular, the backwall 104 includes five openings 108 in the illustrated embodiment. In other embodiments, the backwall 104 can include a greater (e.g., six or more) or lesser (e.g., four or less, including zero) number of openings 108.

Additionally, or alternatively, all or a subset of the sidewalls 103a-103d can include one or more openings 109 (e.g., holes, cutouts, slots, etc.) extending through the sidewalls 103a-103d. In the illustrated embodiment, the sidewalls 103a and 103c each include eleven openings 109, and the sidewalls 103b and 103d lack openings 109. In other embodiments, the sidewalls 103a and/or 103c can include a greater (e.g., twelve or more) or lesser (e.g., ten or less, including zero) number of openings, and/or the sidewalls 103b and/or 103d can include a greater (e.g., one or more) number of openings 109.

The opening(s) 108 and/or the opening(s) 109 are configured to (a) permit air or another medium to flow through at least a portion of the cryocassette 100 and/or (b) expose at least a portion of a cryobag stored within the cryocassette 100 to the air or other medium. Thus, in comparison to other cryogenic cassettes, the opening(s) 108 and/or the opening(s) 109 are expected to improve the flow of air or another medium (a) through the cryocassette 100 and/or (b) throughout a controlled-rate freezer, liquid nitrogen storage container, or another instrument in which the cryocassette 100 is positioned. In turn, the improved flow of air or another medium is expected to (a) improve heat exchange with biological material stored in a cryobag positioned within the cryocassette 100, and/or (b) provide a greater amount of control over and/or uniformity of cooling/freezing the biological material.

All or a subset of the opening(s) 108 and/or 109 can be drilled, punched, or otherwise manually created in the body portion 102. Additionally, or alternatively, the backwall 104 and/or one or more of the sidewalls 103a-103d can be manufactured (e.g., via injection molding and/or 3D printing) with all or a subset of the opening(s) 108 and/or 109, respectively, such that drilling, punching, and/or other manual manufacturing techniques are not required to create one or more of the opening(s) 108 and/or 109 in the body portion 102. In some embodiments, all or a subset of the opening(s) 108 and/or 109 can be formed without (a) rough or sharp edges and/or (b) rough or sharp corners. For example, the opening(s) 108 and/or 109 can be formed with rounded or blunted edges and/or corners.

In the illustrated embodiment, the body portion 102 is opaque. In other embodiments, all or a portion of the body portion 102 (e.g., the backwall 104) can be transparent or semi-transparent. The transparency of all or a portion of the body portion 102 can facilitate viewing a cryobag positioned within the cryocassette 100 (e.g., without requiring removal of the cover 10 from the body portion 102 of the cryocassette 100). For example, while a cryobag is positioned within the cryocassette 100 and the cover 110 is fully installed in the body portion 102, the transparency of all or a portion of the body portion 102 can facilitate viewing (a) biological material stored within the cryobag and/or (b) information printed on a label affixed to the cryobag and/or on the cryobag itself.

The cover 110 of the cryocassette 100 includes a planar portion 112, a lip 113, and a ridge 115. The planar portion 112, the lip 113, and/or the ridge 115 can be manufactured such that they lack (a) rough or sharp edges and/or (b) rough or sharp corners. For example, the planar portion 112, the lip 113, and/or the ridge 115 can be formed with rounded or blunted edges and/or corners.

The planar portion 112 includes an inner surface 110a and an outer surface 110b on a side of the planar portion 112 opposite the inner surface 110a. In the illustrated embodiment, the planar portion 112 has a size and shape that is slightly larger than but generally corresponds to the size and shape of the backwall 104 of the body portion 102. As described in greater detail below, the planar portion 112 is configured to, when the cryobag is positioned on the inner surface 104a of the backwall 104 and the cover 110 is installed within the body portion 102, retain a cryobag within the cryocassette 100 and between the inner surface 104a of the backwall 104 of the body portion 102 and the inner surface 110a of the planar portion 112.

The lip 113 of the cover 110 extends generally perpendicular to the planar portion 112 from an edge of the planar portion 112. In some embodiments, the lip 113 has a height such that the lip 113 abuts against the sidewall 103d and/or the backwall 104 of the body portion 102 when the planar portion 112 is inserted into the notch 106 in the sidewalls 103a-103c and the cover 110 is fully installed within the body portion 102. Additionally, or alternatively, the height of the lip 113 can permit the lip 113 to interface with a retention feature (e.g., a ridge or groove, not shown) on the backwall 104 and/or the sidewall 103d of the body portion 102 to facilitate retaining the cover 110 within the body portion 102 when the cover 110 is fully installed within the body portion 102. In these and other embodiments, the cover 110 and/or the body portion 102 can include another retention mechanism (e.g., a latch, a stop, etc.) for retaining the cover 110 within the body portion 102 when the cover 110 is fully inserted into the body portion 102. In these and still other embodiments, the cover 110 can be retained within the body portion 102 at least in part by friction between (a) edge portions of the planar portion 112 of the cover 110 and (b) the sidewalls 103a-103c and/or the notch 106 of the body portion 102.

Although illustrated without openings in FIG. 1, the planar portion 112 and/or the lip 113 of the cover 110 can include one or more openings (e.g., holes, cutouts, slots, etc.) similar to the opening(s) 108 and/or the opening(s) 109 formed in the backwall 104 and/or the sidewall(s) 103 of the body portion 102. Similar manufacturing techniques used to form the opening(s) 108 and/or the opening(s) 109 can be used to form the one or more openings in the cover 110. The opening(s) formed in the cover 110 can have rounded or blunted edges and/or corners. Like the opening(s) 108 and/or the opening(s) 109 formed in the body portion 102, the opening(s) formed in the cover 110 can permit air or another medium to flow through at least a portion of the cryocassette 100. Thus, the opening(s) in the cover 110 are similarly expected to (a) improve the flow of air or another medium through the cryocassette 100; (b) improve the flow or air or another medium throughout a controlled-rate freezer, liquid nitrogen storage container, or another instrument in which the cryocassette 100 is positioned; (c) improve heat exchange with biological material stored in a cryobag positioned within the cryocassette 100; and/or (d) improve control over and/or uniformity of cooling/freezing the biological material.

In these and other embodiments, the lip 113 can include a slot 117 (e.g., a notch, a slit, an opening, a hole, a cutout, etc.). The slot 117 can permit an electrical lead (not shown) to pass through the slot 117 and into an interior of the cryocassette 100 such that the electrical lead is not pinched when the cover 110 is inserted into the body portion 102. The electrical lead can be coupled to a sensor or another electrical device (not shown) installed within the cryocassette (e.g., installed on or in the cryobag). For example, a thermocouple or other sensor can be attached to a surface of cryobag positioned within the cryocassette 100 and can be configured to monitor a temperature or other data related to the biological material. Temperature measurements and/or other data collected by the sensor can be transmitted outside the cryocassette 100 via the electrical lead (such as to a controlled-rate freezer within which the biological material is stored).

Although illustrated at approximately a center of the lip 113, the slot 117 can be positioned at other locations on the cryocassette 100 in other embodiments. For example, the body portion 102 can include at least a portion of the slot 117, and/or the slot 117 can be positioned at other locations on the cover 110 (e.g., at a location off-centered on the lip 113, at a location on the planar portion 112, etc.) than shown in FIG. 1. In some embodiments, the cryocassette 100 can omit the slot 117.

Furthermore, although illustrated with a lip 113 in FIG. 1, the cover 110 can lack a lip 113 in other embodiments. For example, the cover 110 can include only the planar portion 112, the ridge 115, the slot 117, and/or the label 120 in some embodiments. In these and other embodiments, the body portion 102 can slidably receive the planar portion 112 of the cover 110. When the planar portion 112 is fully received in the body portion 102, a rear edge of the planar portion 112 can be positioned (a) generally flush with the sidewall 103d of the body portion 102, (b) extend beyond the sidewall 103d of the body portion 102, or (c) be positioned above the inner surface 104a of the backwall 104 of the body portion 102. In these embodiments, the sidewall 103d of the body portion 102 can retain a cryobag within the cryocassette 100 and at least partially between the planar portion 112 of the cover 110 and the backwall 104 of the body portion 102. In some embodiments, the lip 113 can extend beyond (e.g., be wider) than the planar portion 112 of the cover 110 and/or the inner surface 104a of the backwall 104 of the body portion 102. In these embodiments, the lip 113 can abut against the front edges of the sidewalls 103a and/or 103c (in addition to or in lieu of abutting against the sidewall 103d and/or the leading edge of the backwall 104) when the planar portion 112 is inserted into the notch 106 and the cover 110 is fully installed into the body portion 102.

The ridge 115 can provide a gripping means for a user to slide the cover 110 into or out of the body portion 102. In the illustrated embodiment, the ridge 115 (a) is a block structure with a generally rectangular cross section and (b) is positioned proximate an edge of the planar portion 102 and near the lip 113 of the cover 110. In other embodiments, the ridge 115 can have a different shape, size, position, and/or orientation than shown in FIG. 1. In some embodiments, the cryocassette 100 can include a different gripping means in addition to or in lieu of the ridge 115. For example, the planar portion 102 can include one or more finger holes or slots in some embodiments for a user to place his/her finger(s) to push or pull the cover 110 into or out of the body portion 102 of the cryocassette 100.

As discussed above, the body portion 102 is configured to slidably receive the cover 110 within the notch 106 formed in the sidewalls 103a-103c. For example, a leading edge of the planar portion 112 of the cover 110 can be aligned generally parallel with the notch 106 formed in the sidewalls 103a and 103c. The cover 110 can then be advanced such that side edge portions of the planar portion 112 are received in the notch 106. At this point, the cover 110 can be slid into the body portion 102 (a) until the leading edge of the planar portion 112 is received in the notch 106 formed in the sidewall 103b and/or abuts against the sidewall 103b, and/or (b) until the lip 113 abuts against the sidewall 103d or the backwall 104 and/or interfaces with a retention feature (a ridge or groove) of the body portion 102. The cover 110 can be retained in this closed configuration using a latch, stop, or other retention mechanism.

In some embodiments, the cover 110 is fully removable from the body portion 102 such that the cover 110 and the body portion 102 can be fully separated from one another. In other embodiments, the cover 110 can be partially removable from the body portion 102. For example, the planar portion 112 of the cover 110 can include one or more nubs (not shown) that jut out from the side edge portions of the planar portion 112. In addition, the notch 106 formed in the sidewalls 103a and 103c can terminate at a location along the sidewalls 103a and 103c before the point at which the sidewalls 103a and 103c intersect with the sidewall 103d or intersect a plane parallel with the front edge of the backwall 104. Continuing with this example, after the nubs on the planar portion 112 have been installed within the notch 106 formed in the sidewalls 103a and 103c, the nubs can prevent or hinder the cover 110 from being fully slid out of the body portion 102 by abutting against a portion of the sidewalls 103a and 103c (e.g., at the location where the notch 106 terminates). Regardless of whether the cover 110 is fully or partially removable from the body portion 102, the cover 110 and the body portion 102 are configured to fully or partially separate from one another such that all or a significant majority of the inner surface 104a of the backwall 104 of the body portion 102 is exposed, thereby providing a user a large amount of access to the inner surface 104a of the backwall 104 of the body portion 102.

In the illustrated embodiment, the planar portion 112 of the cover 110 is transparent. The transparency of all or a subset of the planar portion 112 and/or the cover 110 can facilitate viewing a cryobag positioned within the cryocassette 100 (e.g., without requiring removal of the cover 110 from the body portion 102 of the cryocassette 100). For example, while a cryobag is positioned within the cryocassette 100 and the cover 110 is installed in the body portion 102, the transparency of all or a portion of the planar portion 112 and/or the cover 110 can facilitate viewing (a) biological material stored within the cryobag and/or (b) information printed on a label affixed to the cryobag and/or on the cryobag itself. In other embodiments, all or a portion of the planar portion 112 and/or the cover 110 can be opaque or semi-transparent.

In some embodiments, the cover 110 and/or the body portion 102 can include one or more labels 120. For example, the label(s) 120 can be affixed to or printed on (a) an inner surface 110a and/or an outer surface 110b of the planar portion 112 and/or (b) on a surface of the backwall 104 of the body portion 102, such as on a side of the backwall 104 opposite the inner surface 104a. A label 120 is affixed to the outer surface 110b of the cover 110 in FIG. 1.

The label(s) 120 can include various information. For example, a label 120 can include generic information, such as information related to a size, shape, or model of the cryocassette 100. In these and other embodiments, a label 120 can include information specific to a biological material or cryobag stored within the cryocassette 100. For example, a label 120 can serve as a product label or as a release for infusion (RFI) certificate for biological material stored within a cryobag that is positioned within the cryocassette. Continuing with this example, the label 120 can include (a) information that identifies a type, a volume, an age, and/or one or more other characteristics of the biological material; (b) information (e.g., one or more patient identifies, such as name and/or date of birth) that identifies an intended recipient of the biological material; (c) information that identifies equipment necessary to administer or store the biological material; (d) information that identifies appropriate patient dosage(s); and/or (e) information providing instructions for proper handling, storing, or thawing of the cryocassette 100, the cryobag, and/or the biological material. The label(s) 120 can be provided in addition to or in lieu of one or more labels affixed to or printed on a cryobag stored within the cryocassette 100.

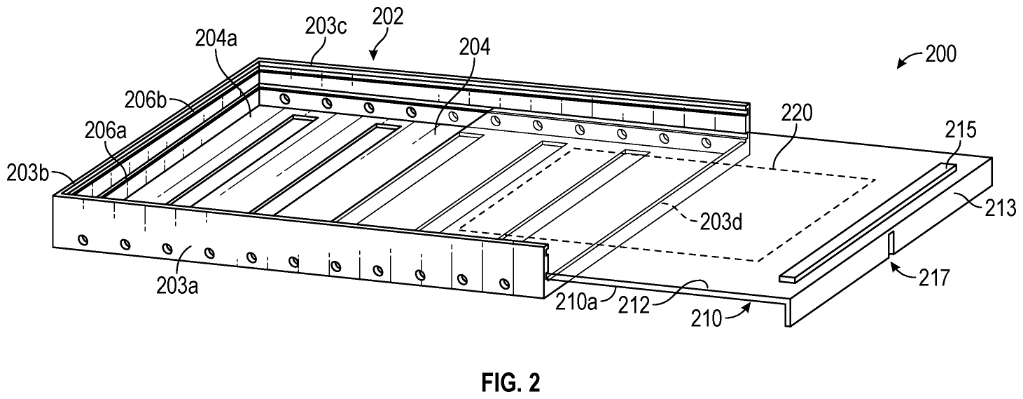

FIG. 2 is a partially schematic, perspective view of another cryogenic cassette 200 (“cryocassette 200”) configured in accordance with various embodiments of the present technology. The cryocassette 200 is similar to the cryocassette 100 of FIG. 1. Thus, similar reference numbers are used in FIG. 2 to indicate identical or at least similar components of the cryocassette 200 to corresponding components of the cryocassette 100. For example, the cryocassette 200 includes a body portion 202 and a cover 210 generally similar to the body portion 102 and the cover 110 of the cryocassette 100 of FIG. 1. The body portion 202 of the cryocassette 200 of FIG. 2 includes (a) a backwall 204 with an inner surface 204a and (b) sidewalls 203 (identified individually as sidewalls 203a-203d in FIG. 2). The cover 210 includes a planar portion 212, a lip 213, a ridge 215, and/or a label 220.

The cryocassette 200 of FIG. 2 differs from the cryocassette 100 of FIG. 1, however, in that the sidewalls 203a-203c of the cryocassette 200 include a plurality of notches 206 (identified individually as notch 206a and notch 206b in FIG. 2). Each of the notches 206a and 206b are configured to (a) receive edge portions of the planar portion 212 of the cover 210 and (b) limit vertical movement of the cover 210 (with respect to the inner surface 204a of the backwall 204 of the body portion 202) while the cover 210 is inserted within the body portion 202. Thus, the plurality of notches 206 facilitate securing cryobags of varying thicknesses within the cryocassette 200 and between the inner surface 204a of the backwall 204 of the body portion 202 and an inner surface 210a of the cover 210.

Additionally, or alternatively, the plurality of notches 206 can facilitate securing different numbers of cryobags within the cryocassette 200. For example, the cover 210 can be inserted into a lower one of the plurality of notches 206 when a single cryobag is stored within the cryocassette 200. As another example, the cover 210 can be inserted into a higher one of the plurality of notches 206 when more than one (e.g., two) cryobags are stored within the cryocassette 200 at the same time. Continuing with this example, a single dose of therapy can be contained within one of the cryobags. Thus, for a patient who requires two doses of therapy, two cryobags corresponding to the two doses can be fit and secured within a same cryocassette 200 at the same time by inserting the cover 210 within one of the higher notches in the plurality of notches 206.

In some embodiments, the heights of the sidewalls 203a-203c can be the same as or different from (e.g., can be greater than) the heights of the sidewalls 103a-103 of the cryocassette 100 of FIG. 1. In these and other embodiments, the sidewalls 203a-203c can include more than two notches 206. The notches 206 can be uniformly spaced from one another, or distances between adjacent notches 206 can vary.

Additionally, or alternatively, a height of the lip 213 of the cover 210 can be the same as or different from (e.g., can be greater than) the height of the lip 113 of the cover 110 in FIG. 1. In these and other embodiments, a size of a slot 217 formed in the lip 213 can be the same as or different from (e.g., can be greater or taller than) the size of the slot 117 of FIG. 1. The lip 213 can be configured to abut against the sidewall 203d and/or the backwall 204 when the cover 210 is fully installed within the body portion 202. In these and other embodiments, the lip 213 can be configured such that it is positioned generally flush with the sidewall 203d and/or a front edge of the backwall 204 when the cover 210 is fully installed in the body portion 202 (e.g., in a highest notch 206 formed in the sidewalls 203a-203c). In some embodiments, the lip 213 can engage with a retention feature (e.g., a ridge or groove, not shown) on the backwall 204 and/or the sidewall 203d to facilitate retaining the cover 210 within the body portion 202 when the cover 210 is fully installed within one of the notches 206 of the body portion 202. In these and other embodiments, the cover 210 and/or the body portion 202 can include another retention mechanism (e.g., a latch, a stop, etc.) for retaining the cover 210 within the body portion 202 when the cover 210 is fully inserted into the body portion 202. In these and still other embodiments, the cover 210 can be retained within the body portion 202 at least in part by friction between (a) edge portions of the planar portion 212 of the cover 210 and (b) the sidewalls 203a-203c and/or one of the notches 206 of the body portion 202.

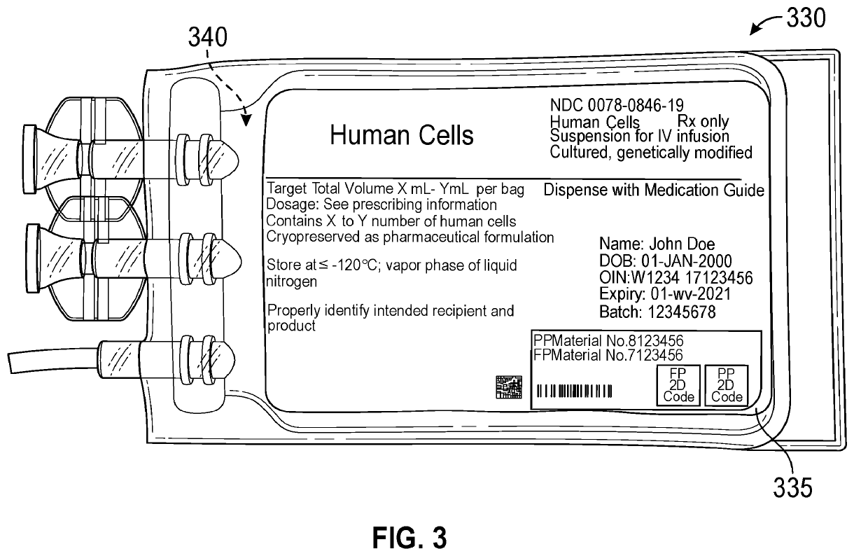

FIG. 3 is a front view of a cryopreservation bag 330 (“cryobag 330”) configured in accordance with various embodiments of the present technology. The cryobag 330 can be formed of a thermoplastic or another material that maintains integrity at cryogenic temperatures. The cryobag 330 in the illustrated embodiment has a generally rectangular shape that corresponds to the generally rectangular shape of the cryocassette 100 of FIG. 1 and/or of the cryocassette 200 of FIG. 2. In other embodiments, the cryobag 330 can have a different general shape.

The cryobag 330 is configured to retain biological material 340 within an interior of the cryobag 330. Examples of biological material 340 that can be stored within the cryobag 330 include organelles, cells, tissues, or any other biological constructs. In the illustrated embodiment, the biological material 340 includes human cells, such as human T-cells.

The cryobag 330 can include a label 335 including various information. The label 335 can include an identification of the biological material 340, dosage information, storage and administration instructions, one or more patient identifiers indicating an intended recipient, and/or other information. As discussed above, all or a portion of this information can be included on a label (e.g., the label 120 or the label 220) affixed to or printed on a cryocassette corresponding to the cryobag 330. In some embodiments, the label on the cryocassette can be provided in addition to or in lieu of the label 335 on the cryobag 330.

FIG. 4A is a partially schematic, perspective view of a cryogenic cassette 400 (“cryocassette 400”) installed (e.g., partially) in a storage rack 460 configured in accordance with various embodiments of the present technology. In addition, FIG. 4B is a partially schematic, perspective view of the cryocassette 400 installed in another storage rack 465 configured in accordance with various embodiments of the present technology. The cryocassette 400 can be the cryocassette 100 of FIG. 1, the cryocassette 200 of FIG. 2, or another cryocassette configured in accordance with various embodiments of the present technology.

As shown in FIG. 4A, the storage rack 460 is generally block- or rectangular-shaped and includes nine slots 462 (identified individually as slots 462a-462i in FIG. 4A) that are each configured to receive, support, and/or retain a cryocassette 400 of the present technology. Similarly, the storage rack 465 of FIG. 4B is generally rectangular-shaped and includes four slots 467 (identified individually as slots 467a-467d in FIG. 4B) that are each configured to receive, support, and/or retain a cryocassette 400 of the present technology. In particular, the slots 462 and 467 are each dimensioned such that a cryocassette 400 can be slid into one of the slots 462a-462i and/or 467a-467d for storage in the racks 460 and/or 465, respectively. In other embodiments, the storage racks 460 and/or 465, and/or one or more of the slots 462 and/or 467, can include a different general shape, such as a circle, pentagon, hexagon, octagon, etc. In these and other embodiments, the storage racks 460 and/or 465 can include a different (e.g., ten or more, or eight or fewer for the storage rack 460; and/or five or more, or four or fewer for the storage rack 465) number of slots 462 and/or 467 to receive, support, and/or retain another (e.g., ten or more, or eight or fewer for the storage rack 460; and/or five or more, or four or fewer for the storage rack 465) number of the cryocassettes 400 in the storage racks 460 and/or 465, respectively.

In the embodiment illustrated in FIG. 4A, the cryocassette 400 is inserted into the storage rack 460 in a horizontal orientation and along a direction generally parallel with a length of the cryocassette 400. In contrast, the cryocassette 400 is inserted into the storage rack 465 of FIG. 4B in a vertical orientation and along a direction generally parallel with the length of the cryocassette 400. In other embodiments, the cryocassette 400 can be inserted into the storage rack 460 in a vertical orientation, into the storage rack 465 in a horizontal orientation, and/or into the storage racks 460 and/or 465 in another orientation. Additionally, or alternatively, the cryocassette 400 can be inserted into the slots 462 and/or 467 along a direction parallel with a width or a height of the cryocassette 400 (or along another direction).

FIG. 4C is a front view of a controlled-rate freezer 470, and FIG. 4D is a front view of a liquid nitrogen storage container 480. Each is configured in accordance with various embodiments of the present technology. The freezer 470 can be configured to receive the storage rack 460 of FIG. 4A, and the liquid nitrogen storage container 480 can be configured to receive the storage rack 465 of FIG. 4B. Thus, the storage rack 460 can be used to store, organize, and/or separate individual cryocassettes 400 within the freezer 470 (e.g., to facilitate controlled-rate freezing and/or cryopreservation of biological material stored within a cryobag positioned within a cryocassette 400). Similarly, the storage rack 465 can be used to store, organize, and/or separate individual cryocassettes 400 within the liquid nitrogen storage container 480 (e.g., to facilitate freezing and/or cryopreservation of biological material stored within a cryobag positioned within a cryocassette 400).

The controlled-rate freezer 470 and/or the liquid nitrogen storage container 480 can be generic or customized instruments. Additionally, or alternatively, the storage racks 460 and/or 465 can be a generic or customized storage racks. For example, the cryocassette 400 can be shaped and sized for storage within a customized storage rack 460 and/or 465 tailored specifically (a) for the cryocassette 400, (b) for a controlled-rate freezer 470, and/or (c) for a liquid nitrogen storage container 480. As another example, the cryocassette 400 can be shaped and sized for storage within a conventional storage rack 460 and/or 465 that is commonly used for a controlled-rate freezer 470 or for a liquid nitrogen storage container 480. In some embodiments, the cryocassette 400 can be shaped and sized for storage within a storage rack that corresponds to both a controller-rate freezer 470 and to a liquid nitrogen storage container 480.

In some embodiments, the storage rack 460 of FIG. 4A can be installed within the controlled-rate freezer 470 such that the slots 462 of the storage rack 460 position the cryocassettes 400 in a generally horizontal orientation within the controlled-rate freezer 470 and/or in an orientation generally parallel to a flow of air or another cooling medium in the controlled-rate freezer 470. Additionally, or alternatively, the storage rack 460 can be installed within the controlled-rate freezer 470 such that the slots 462 of the storage rack 460 position the cryocassettes 400 in a generally vertical or other (e.g., non-vertical and non-horizontal) orientation within the controlled-rate freezer 470. Furthermore, the storage rack 465 of FIG. 4B can be installed within the liquid nitrogen storage container 480 such that the slots 467 of the storage rack 465 position the cryocassettes 400 in a generally vertical orientation within the liquid nitrogen storage container 480 and/or in an orientation generally parallel to a flow of liquid nitrogen or another cooling medium in the liquid nitrogen storage contained 480. In these and other embodiments, the storage rack 465 can be installed within the liquid nitrogen storage container 480 such that the slots 467 position the cryocassettes 400 in a generally horizontal or other (e.g., non-vertical and non-horizontal) orientation within the liquid nitrogen storage container 480.

### 2. Associated Methods

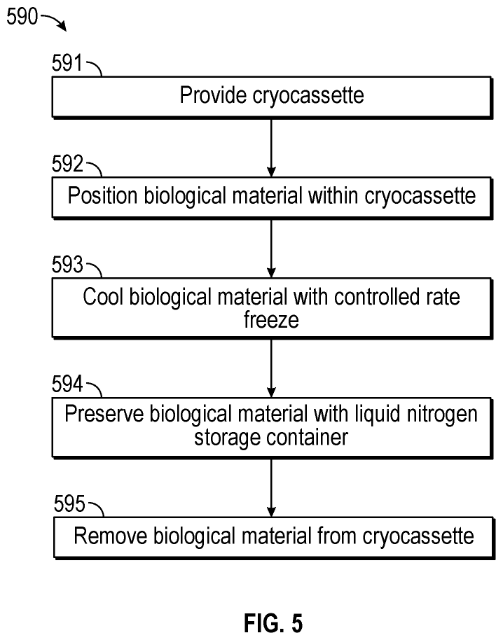

FIG. 5 is a flow diagram illustrating a method 590 of cryopreserving biological material in accordance with various embodiments of the present technology. All or a subset of the steps of the method 590 can be executed by various components or devices of a cryopreservation system, such as the cryocassette 100 of FIG. 1, the cryocassette 200 of FIG. 2, the cryocassette 400 of FIG. 4A, the cryobag 330 of FIG. 3, the storage rack 460 of FIG. 4A, the storage rack 465 of FIG. 4B, the controlled-rate freezer 470 of FIG. 4C, and/or the liquid nitrogen storage container 480 of FIG. 4D. Additionally, or alternatively, all or a subset of the steps of the method 590 can be executed by a user (e.g., an operator, a technician, an engineer, a patient, etc.) of at least a portion of the cryopreservation system. Furthermore, any one or more of the steps of the method 590 can be executed in accordance with the discussion above.

The method 590 begins at block 591 by providing a cryocassette. The cryocassette can be the cryocassette 100 of FIG. 1, the cryocassette 200 of FIG. 2, the cryocassette 400 of FIGS. 4A and 4B, and/or another cryocassette configured in accordance with various embodiments of the present technology. In accordance with the discussion of FIGS. 1-4D above, the cryocassette can include a cover and a body portion configured to slidably receive the cover.

At block 592, the method 590 continues by positioning biological material within the cryocassette. The biological material can include organelles, cells, tissues, and/or any other biological constructs. In some embodiments, positioning biological material within the cryocassette can include positioning the biological material within a cryobag, such as the cryobag 330 of FIG. 3. Additionally, or alternatively, positioning the biological material within the cryocassette can include removing the cover from the body portion of the cryocassette or otherwise positioning the cryocassette in an open configuration. For example, positioning the cryocassette in the open configuration can include releasing a retention mechanism or overcoming a retention feature holding the cover within the body portion. Positioning the cryocassette in the open configuration can include sliding the cover (e.g., using a ridge on the cover or another gripping mechanism) along and/or out of a notch formed in sidewalls of the body portion until the cover is fully or partially removed from the body portion and/or until an inner surface of a backwall of the body portion is exposed.

In these and other embodiments, positioning the biological material within the cryocassette includes positioning a cryobag containing the biological material on the inner surface of the backwall and/or such that sidewalls of the body portion at least generally surround a perimeter of the cryobag. Positioning the biological material within the cryocassette can additionally or alternatively include installing a sensor (e.g., a thermocouple or other sensor) within an interior of the cryocassette (e.g., on or in the cryobag) and/or feeding an electrical lead coupled to the sensor through a slot in the cover or in the body portion of the cryocassette.

In these and still other embodiments, positioning the biological material within the cryocassette can include positioning the cryocassette in a closed configuration. In some embodiments, positioning the cryocassette in the closed configuration can include inserting the cover into a notch formed in the body portion. Additionally, or alternatively, positioning the cryocassette in the closed configuration can include sliding the cover into the body portion until a lip of the cover abuts against the body portion, until the lip interfaces with a retention feature of the body portion, and/or until a leading edge of a planar portion of the cover abuts against a sidewall of the body portion. When the cryocassette is placed in the closed configuration with a cryobag positioned on the inner surface of the backwall of the body portion, the biological material can be contained at least in part within the cryocassette between the inner surface of the backwall and an inner surface of the planar portion of the cover. The sidewalls of the body portion and/or the lip of the cover can prevent the biological material from slipping out from between these inner surfaces of the cryocassette. In some embodiments, positioning the biological material within the cryocassette can include engaging a retention mechanism to retain the cover within the body portion and/or lock the cryocassette in the closed configuration. In these and other embodiments, positioning the biological material within the cryocassette can include placing (e.g., affixing, printing, etc.) a label corresponding to the biological material or the cryobag on the cover or another portion (e.g., the body portion) of the cryocassette.

At block 593, the method 590 continues by cooling biological material with a controlled-rate freezer. In some embodiments, cooling the biological material with a controlled-rate freezer can include positioning a cryocassette containing the biological material within the controlled-rate freezer. Positioning the cryocassette within a controlled-rate freezer can include positioning the cryocassette in a storage rack (e.g., by sliding or otherwise installing the cryocassette in a slot of the storage rack configured to carry and/or retain the cryocassette within the storage rack), such as the storage rack 460 of FIG. 4A. The storage rack can be removably positioned within the controlled-rate freezer. In these embodiments, positioning the cryocassette within the controlled-rate freezer can include positioning the storage rack within the controlled-rate freezer. Alternatively, the storage rack can be permanently positioned within the controlled-rate freezer. Positioning the cryocassette within the controlled-rate freezer can include positioning the cryocassette in a horizontal, vertical, or other orientation within the storage rack and/or within the controlled-rate freezer. Positioning the cryocassette within the controlled-rate freezer can include removing the cryocassette from another instrument, such as from a liquid nitrogen storage container.

Cooling the biological material with a controlled-rate freezer can include cooling the biological material in accordance with a specified rate. Cooling the biological material with a controlled-rate freezer can include receiving data (e.g., temperature measurements) from a sensor or another electronic device installed within the cryocassette of the controlled-rate freezer. Cooling the biological material within the controlled-rate freezer can include cooling the biological material based at least in part on the data received from the sensor or the other electronic device installed within the cryocassette or controlled-rate freezer.

At block 594, the method 590 continues by preserving biological material with a liquid nitrogen storage container. In some embodiments, preserving the biological material with a liquid nitrogen storage container can include positioning a cryocassette containing the biological material within the liquid nitrogen storage container. Positioning the cryocassette within a liquid nitrogen storage container can include positioning the cryocassette in a storage rack (e.g., by sliding or otherwise installing the cryocassette in a slot of the storage rack configured to carry and/or retain the cryocassette within the storage rack), such as the storage rack 465 of FIG. 4B. The storage rack can be removably positioned within the liquid nitrogen storage container. In these embodiments, positioning the cryocassette within the liquid nitrogen storage container can include positioning the storage rack within the liquid nitrogen storage container. In some embodiments, the storage rack can be a same or similar storage rack used to position the biological material within a controlled-rate freezer at block 593. Alternatively, the storage rack can be a different storage rack from the storage rack used to position the biological material within the controlled-rate freezer at block 593, and/or the storage rack can be permanently positioned within the liquid nitrogen storage container. Positioning the cryocassette within the liquid nitrogen storage container can include positioning the cryocassette in a vertical, horizontal, or other orientation within the storage rack and/or within the liquid nitrogen storage container. Positioning the cryocassette within the liquid nitrogen storage container can include removing the cryocassette from another instrument, such as from a controlled-rate freezer. Preserving the biological material with the liquid nitrogen storage container can include reducing a temperature of the biological material to cryogenic temperatures.

At block 595, the method 590 continues by removing the biological material from the cryocassette. In some embodiments, removing the biological material from the cryocassette can include removing a storage rack and/or removing the cryocassette from an instrument, such as from a controlled-rate freezer and/or a liquid nitrogen storage container. Removing the cryocassette from the storage rack can include sliding or uninstalling the cryocassette from a slot of a storage rack configured to carry and/or retain the cryocassette within the storage rack. Removing the biological material from the cryocassette can include removing the cover from the body portion of the cryocassette or otherwise positioning the cryocassette in an open configuration. For example, positioning the cryocassette in the open configuration can include releasing a retention mechanism or overcoming a retention feature retaining the cover within the body portion. Positioning the cryocassette in the open configuration can include sliding the cover (e.g., using a ridge on the cover or another gripping mechanism) along and/or out of a notch formed in sidewalls of the body portion until the cover is fully or partially removed from the body portion and/or until a cryobag containing the biological material and/or an inner surface of a backwall of the body portion is exposed. In these and other embodiments, removing the biological material from the cryocassette includes retrieving a cryobag containing the biological material from within an interior of the body portion and/or of the cryocassette. Removing the biological material from the cryocassette can include following instructions (e.g., handling instructions, storage instructions, administering instructions, dosage instructions, etc.) printed on a label on the cryocassette and/or on the cryobag. Removing the biological material from the cryocassette can include ensuring one or more patient identifiers printed on a label on the cryocassette and/or on the cryobag match a patient to whom the biological material is to be administered. Removing the biological material from the cryocassette can include allowing the cryocassette, the cryobag, and/or the biological material to thaw. Removing the biological material from the cryocassette can include administering the biological material to a patient, testing the biological material, or otherwise handling the biological material.

Although the steps of the method 590 are discussed and illustrated in a particular order, the method 590 of FIG. 5 is not so limited. In other embodiments, the steps of the method 590 can be performed in a different order. In these and other embodiments, any of the steps of the method 590 can be performed before, during, and/or after any of the other steps of the method 590. Furthermore, a person skilled in the art will readily recognize that the method 590 can be altered and still remain within these and other embodiments of the present technology. For example, one or more steps of the method 590 can be omitted and/or repeated in some embodiments.

### C. Examples

Several aspects of the present technology are set forth in the following examples. Although several aspects of the present technology are set forth in apparatus-, system-, or method-styled examples below, any of the aspects of the present technology can similarly be set forth in other styles of examples in other embodiments.
1. A cryocassette, comprising:
a cover; and
a body portion having a backwall and a plurality of sidewalls, wherein:
   the backwall and the plurality of sidewalls form a tray structure for carrying a cryobag, and
   the plurality of sidewalls is configured to slidably receive the cover for retaining the cryobag between the backwall and the cover.
2. The cryocassette of example 1, wherein the plurality of sidewalls is configured to slidably receive the cover within a notch formed in sidewalls of the plurality of sidewalls, and wherein the notch limits vertical movement of the cover with respect to the backwall when the cover is slidably received within the notch.
3. The cryocassette of example 1 or example 2, wherein the backwall includes a plurality of openings that allow air or another medium to flow through the backwall of the cover.
4. The cryocassette of any of examples 1-3, wherein one or more sidewalls of the plurality of sidewalls include at least one opening that allows air or another medium to flow through respective sidewalls of the one or more sidewalls.
5. The cryocassette of any of examples 1-4, wherein the cover includes a planar portion, and wherein the plurality of sidewalls is configured to slidably receive the planar portion.
6. The cryocassette of example 5, wherein:
the cover further includes a lip generally perpendicular to the planar portion; and
the lip is sized such that, when the planar portion is slidably received in the plurality of sidewalls and the cover is fully inserted into the body portion, the lip abuts against a sidewall of the body portion or an edge of the backwall.
7. The cryocassette of example 5, wherein:
the cover further includes a lip generally perpendicular to the planar portion; and
the lip is sized such that, when the planar portion is slidably received in the plurality of sidewalls and the cover is fully inserted into the body portion, the lip is generally flush with an edge of the backwall.
8. The cryocassette of any of examples 1-7, wherein:
the cover includes a lip generally perpendicular to the backwall of the body portion when the cover is slidably received in the plurality of sidewalls; and
the lip includes a slot configured to permit an electrical lead to pass through the lip.
9. The cryocassette of any of examples 1-8, wherein the cover includes a ridge or openings for gripping or sliding the cover into or out of the body portion.
10. The cryocassette of any of examples 1-9, wherein the cover and/or the body portion are transparent.
11. The cryocassette of any of examples 1-10, wherein only a portion of the cover and/or only a portion of the body portion are transparent.
12. The cryocassette of any of examples 1-11, further comprising a product label affixed to or printed on the cover and/or on the body portion, wherein the product label corresponds to a product contained within the cryobag.
13. The cryocassette of any of examples 1-12, wherein the cover includes a plurality of openings that allow air or another medium to flow through the cover.
14. The cryocassette of any of examples 1-13, further comprising a latch or lock configured to retain the cover within the body portion when the cover is slidably received in the plurality of sidewalls and the cover is fully inserted into the body portion.
15. The cryocassette of any of examples 1-14, wherein the cover and the body portion are configured to fully separate from one another by sliding the cover out of the body portion.
16. The cryocassette of any of examples 1-14, wherein the cover and the body portion are configured to only partially separate from one another by sliding the cover out of the body portion.
17. A system, comprising:
a cryocassette having a cover and a body portion configured to slidably receive the cover; and
a storage rack positionable within a controlled-rate freezer or a liquid nitrogen storage container,
wherein the storage rack includes a slot configured to slidably receive and carry the cryocassette.
18. The system of example 17, further comprising a sensor configured to attach to a cryobag positioned within the cryocassette, wherein the sensor is electrically coupled to an electrical lead, and wherein the cover of the cryocassette includes a slot configured to allow the electrical lead to pass through the cover.
19. A method, comprising:
providing a cryocassette having a cover and a body portion configured to slidably receive the cover; and
positioning a cryobag within the cryocassette.
20. The method of example 19, wherein:
positioning the cryobag within the cryocassette includes positioning the cryocassette in an open configuration and positioning the cryobag on a backwall of the body portion; and
positioning the cryobag in the open configuration includes sliding the cover out from the body portion and along a notch formed in sidewalls of the body portion.
21. The method of example 19 or example 20, wherein:
positioning the cryobag includes positioning the cryocassette in a closed configuration; and
positioning the cryocassette in the closed configuration includes sliding the cover into the body portion and along a notch formed in sidewalls of the body portion such that the cryobag is retained within the cryocassette between a backwall of the body portion and the cover.

### D. Conclusion

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, although steps are presented in a given order above, alternative embodiments may perform steps in a different order. Furthermore, the various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated by reference herein conflicts with the present disclosure, the present disclosure controls.

Where the context permits, singular or plural terms may also include the plural or singular term, respectively. In addition, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, an exemplary step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.” Also, the terms “connect” and “couple” are used interchangeably herein and refer to both direct and indirect connections or couplings. For example, where the context permits, element A “connected” or “coupled” to element B can refer (i) to A directly “connected” or directly “coupled” to B and/or (ii) to A indirectly “connected” or indirectly “coupled” to B.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments. Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A cryocassette, comprising:
a cover; and
a body portion having a backwall and a plurality of sidewalls,
wherein:
the backwall and the plurality of sidewalls form a tray structure for carrying a cryobag, and
the plurality of sidewalls is configured to slidably receive the cover for retaining the cryobag between the backwall and the cover.

2. The cryocassette of claim 1, wherein the plurality of sidewalls is configured to slidably receive the cover within a notch formed in sidewalls of the plurality of sidewalls, and wherein the notch limits vertical movement of the cover with respect to the backwall when the cover is slidably received within the notch.

3. The cryocassette of claim 1, wherein the backwall includes a plurality of openings that allow air or another medium to flow through the backwall of the cover.

4. The cryocassette of claim 1, wherein one or more sidewalls of the plurality of sidewalls include at least one opening that allows air or another medium to flow through respective sidewalls of the one or more sidewalls.

5. The cryocassette of claim 1, wherein the cover includes a planar portion, and wherein the plurality of sidewalls is configured to slidably receive the planar portion.

6. The cryocassette of claim 5, wherein:
the cover further includes a lip generally perpendicular to the planar portion; and
the lip is sized such that, when the planar portion is slidably received in the plurality of sidewalls and the cover is fully inserted into the body portion, the lip abuts against a sidewall of the body portion or an edge of the backwall.

7. The cryocassette of claim 5, wherein:
the cover further includes a lip generally perpendicular to the planar portion; and
the lip is sized such that, when the planar portion is slidably received in the plurality of sidewalls and the cover is fully inserted into the body portion, the lip is generally flush with an edge of the backwall.

8. The cryocassette of claim 1, wherein:
the cover includes a lip generally perpendicular to the backwall of the body portion when the cover is slidably received in the plurality of sidewalls; and
the lip includes a slot configured to permit an electrical lead to pass through the lip.

9. The cryocassette of claim 1, wherein the cover includes a ridge or openings for gripping or sliding the cover into or out of the body portion.

10. The cryocassette of claim 1, wherein the cover and/or the body portion are transparent.

11. The cryocassette of claim 1, wherein only a portion of the cover and/or only a portion of the body portion are transparent.

12. The cryocassette of claim 1, further comprising a product label affixed to or printed on the cover and/or on the body portion, wherein the product label corresponds to a product contained within the cryobag.

13. The cryocassette of claim 1, wherein the cover includes a plurality of openings that allow air or another medium to flow through the cover.

14. The cryocassette of claim 1, further comprising a latch or lock configured to retain the cover within the body portion when the cover is slidably received in the plurality of sidewalls and the cover is fully inserted into the body portion.

15. The cryocassette of claim 1, wherein the cover and the body portion are configured to fully separate from one another by sliding the cover out of the body portion.

16. The cryocassette of claim 1, wherein the cover and the body portion are configured to only partially separate from one another by sliding the cover out of the body portion.

17. A system, comprising:
a cryocassette having a cover and a body portion configured to slidably receive the cover; and
a storage rack positionable within a controlled-rate freezer or a liquid nitrogen storage container,
wherein the storage rack includes a slot configured to slidably receive and carry the cryocassette.

18. The system of claim 17, further comprising a sensor configured to attach to a cryobag positioned within the cryocassette, wherein the sensor is electrically coupled to an electrical lead, and wherein the cover of the cryocassette includes a slot configured to allow the electrical lead to pass through the cover.

19. A method, comprising:
providing a cryocassette having a cover and a body portion configured to slidably receive the cover; and
positioning a cryobag within the cryocassette.

20. The method of claim 19, wherein:
positioning the cryobag within the cryocassette includes positioning the cryocassette in an open configuration and positioning the cryobag on a backwall of the body portion; and
positioning the cryobag in the open configuration includes sliding the cover out from the body portion and along a notch formed in sidewalls of the body portion.

21. The method of claim 19, wherein:
positioning the cryobag includes positioning the cryocassette in a closed configuration; and
positioning the cryocassette in the closed configuration includes sliding the cover into the body portion and along a notch formed in sidewalls of the body portion such that the cryobag is retained within the cryocassette between a backwall of the body portion and the cover.
